(19) United States
(12) Patent Application Publication
(10) Pub. No.: US 2020/0172379 A1
(43) Pub. Date: Jun. 4, 2020

(54) LINEAR MOTOR ARRANGEMENT COMPRISING TWO DRIVE TRAINS

(71) Applicants: THYSSENKRUPP ELEVATOR AG, Essen (DE); thyssenkrupp AG, Essen (DE)

(72) Inventor: Juergen FRANTZHELD, Munich (DE)

(73) Assignees: THYSSENKRUPP ELEVATOR AG, Essen (DE); thyssenkrupp AG, Essen (DE)

(21) Appl. No.: 16/621,968

(22) PCT Filed: Jun. 19, 2018
(86) PCT No.: PCT/EP2018/066244

§ 371 Date: Dec. 12, 2019

(30) Foreign Application Priority Data
Jun. 21, 2017 (DE) 10 2017 210 428.7

(51) Int. Cl. B66B 11/04; H02K 41/03; B66B 11/00

(52) U.S. Cl. CPC B66B 11/0407; B66B 11/0045; H02K 41/031

(57) ABSTRACT

A linear motor arrangement for an elevator installation and a car movable along a first and second track. The linear motor arrangement is configured to drive the car. The linear motor arrangement includes a first drive train arranged along the first track, and a second drive train arranged along the second track. The first drive train differs from the second drive train in at least one property and forms an angle relative to the second track. A linear motor arrangement is disclosed for an elevator installation, wherein the elevator installation includes a car which is movable along a first and second track. The linear motor arrangement comprises a first drive train arranged along the first track, and a second drive train arranged along the second track, wherein the first drive train is configured to provide a higher drive power density than the second drive train.

### TECHNICAL FIELD

The invention relates to a linear motor arrangement for an elevator installation. Such an elevator installation comprises at least one car which can move along a track. The linear motor arrangement is suitable for driving this car in the direction of the track.

### TECHNICAL BACKGROUND

Such linear motors are particularly used in elevator installations which are driven without a driving rope. Along the track of the car there extends a drive train having a plurality of drive modules which generate a magnetic field which travels concomitantly with the car. A rotor unit which is fixedly attached to the car is impinged by the traveling magnetic field, with the result that the car is driven.

Current trends are toward so-called multicar systems in which a plurality of cars are accommodated such that they can be moved in a common elevator shaft. It is particularly advantageous here if, in addition to a vertical track, the elevator systems also provide for a lateral, in particular horizontal, movement of the cars.

US2016/0297648 A1 describes a multicar system having a linear motor arrangement and a transfer station, wherein the drive power is reduced upon vertical movement into the transfer station.

### SUMMARY OF THE INVENTION

It is an object of the present invention to provide an improved linear motor arrangement in which the drive train is adapted to the direction of the track and to the function of the track.

The object on which the invention is based is achieved by a linear motor arrangement as claimed in claim 1 or claim 2 and by an elevator installation as claimed in claim 12; preferred embodiments will emerge from the dependent claims and from the description which follows.

The linear motor arrangement is suitable for an elevator installation, wherein the elevator installation comprises at least one car which can move along a first track and a second track. In this case, the linear motor arrangement is suitable for driving the car. The linear motor arrangement comprises a first drive train which is arranged along the first track. Furthermore, the linear motor arrangement comprises a second drive train which is arranged along the second track. The first track here forms an angle relative to the second track, and the first drive train differs from the second drive train in at least one property. The different configuration of the drive trains makes it possible to bring about an adaptation to the orientation of the corresponding tracks. Depending on the orientation of the tracks in three-dimensional space, there is a requirement, for example, for different drive powers in order to move a car along the corresponding track.

In one specific embodiment of the invention, the first drive train is therefore suitable for providing a higher drive power density than the second drive train. The drive power density is defined as the drive power per distance along the track.

In addition to the configuration of the drive train, the transmitted drive power of course also depends on the configuration of the rotor unit. In particular, the drive power is dependent on the number and magnetic field strength of the rotor magnets. If, within the context of this application, the drive powers or drive power density of two different drive trains are compared, this comparison is to be understood in such a way that the drive powers in both drive trains are transmitted to identical rotor units.

Different drive powers for the different drive trains can be required for different reasons. On the one hand, a higher drive power can be required in the vertical drive train since, during an upward movement of the car, the weight force is oppositely directed to the driving force. If this is compared with an otherwise identically structured horizontal track, the weight force in the horizontal track is taken up by a guide, in particular a roller guide. By contrast to the upward movement, only the inertia and the frictional forces of the guide have to be overcome during a horizontal movement. Consequently, smaller drive powers are required for a horizontal track. On the other hand, different drive powers can also be advantageous on account of different mechanical configurations of the tracks. For example, roller guides for vertical and horizontal tracks are not necessarily of identical design. Horizontal transport is nowadays fairly unusual for passengers, and therefore higher travel comfort is desirable here. This results in turn in the fact that the guide for horizontal transport is configured to be different and thus comprises different frictional forces. Configurations are thus also conceivable in which a higher drive power is required in the horizontal direction than in the vertical direction. In another scenario, the passengers would be allowed a higher degree of comfort during horizontal transport by virtue of only a low starting acceleration or a low speed movement in the horizontal direction. This avoids a situation in which passengers could fall over. For such slow horizontal transport, a smaller drive power is also sufficient in horizontal drive trains. Corresponding scenarios are also conceivable for obliquely extending drive trains.

The adaptation of the drive power density to the orientation of the tracks thus has the advantage that only precisely the drive power is provided by the drive train that is required for moving the car along the corresponding track. This makes it possible for example to provide the drive train in a correspondingly cost-effective manner. No drive power is held available that is not required during operation.

The object is also achieved by a linear motor arrangement suitable for an elevator installation, wherein the elevator installation comprises at least one car which can move along a first track and a second track, and wherein the linear motor arrangement is suitable for driving the car. In this case, the linear motor arrangement comprises a first drive train which is arranged along the first track, and a second drive train which is arranged along the second track. Here, the first drive train is suitable for providing a higher drive power density than the second drive train.

Also independently of the direction of travel, there are regions of the elevator installation that are traveled over only at lower speeds and with low loading of cars. These are for example regions in which cars are temporarily parked. In the case of a multicar system, this may be necessary in order to make the track free for one car. A second car which blocks the track is then moved beforehand into a parking position. Such a parking position can be, for example, at the upper or lower end of a vertical track, that is to say in the shaft head or in the shaft pit. Alternatively, specific parking tracks can also be provided. They can be configured in any desired orientation, in particular also horizontally. It is also possible for cars to be temporarily parked on such parking tracks for inspection and maintenance purposes. In all these cases, it is sufficient if the corresponding region is traveled over at reduced speed and low loading. The second drive train arranged along this second track can therefore be configured in such a way that it provides a smaller drive power density or redundancy. This makes it possible for example to provide the drive train in a correspondingly cost-effective manner. No drive power is held available that is not required during operation.

In a further embodiment of the linear motor arrangement, the first drive train comprises a plurality of first drive modules with a first distance between the first drive modules. Correspondingly, the second drive train comprises a plurality of first drive modules with a second distance between the drive modules. The first drive train differs here from the second drive train by virtue of the fact that the first distance is less than the second distance. The first drive train and the second drive train thus comprise the identical first drive modules. Only the distance between the first drive modules is different in the two drive trains. This is one possibility of realizing a different drive power density in the two drive trains. Each of the first drive modules is suitable for making available a fixed drive power. By virtue of the different distances, the density of the first drive modules in the drive trains is also different. Consequently, the drive power density in the drive trains is also different. In the first drive train in which the first drive modules have a smaller distance apart, the drive power density is higher than in the second drive in which the first drive modules have the greater distance apart. This configuration is a possibility of varying the drive power density that can be realized in a very simple manner and has in particular the advantage that the identical first drive modules can be used. Consequently, the number of the different components can be kept small.

The first drive modules are incorporated in particular into a mounting holder which for its part is fastened to the shaft wall. For this purpose, the mounting holder comprises receptacles which are suitable for each first drive module.

In a developed embodiment variant, the second distance is equal to a third distance between two first drive modules of the first drive train which are not adjacent. In particular, the third distance is present in each case between next but one first drive modules. This configuration has the advantage that the same mounting holders can be used for the first drive train and the second drive train. It is only in the second drive train that every second receptacle of the mounting holder is not equipped during assembly with a first drive module. Otherwise, the mounting holder can be used unchanged, with the result that no separate components are required. The drive power density in the second drive train is thus half the drive power density that the first drive train can provide. Accordingly, just every third, fourth, etc., receptacle of the mounting holder can be equipped with a first drive module. The third distance is then present between every third or every fourth, etc., first drive module. In this way, the drive power density is then correspondingly only a third, quarter, etc., by comparison with a completely equipped mounting holder.

In another embodiment of the linear motor arrangement, the first drive train comprises a plurality of first drive modules, and the second drive train comprises a plurality of second drive modules. In this case, the first drive modules are suitable for providing a higher drive power than the second drive modules. This has the advantage that second drive modules can be used which are more favorable to produce since they have a smaller power output.

In particular, the first drive modules each comprise at least one first stator coil, and the second drive modules each comprise at least one second stator coil. In this case, the first stator coil comprises a different design form than the second stator coil. This means that the first stator coil differs from the second stator coil in at least one of the following properties: number of windings, conducting cross section, coil cross section, material of the conductor, cooling device (in particular number and shape of the cooling ribs), potting material, overall volume (in particular coil width or coil height). In a particularly preferred embodiment, the first stator coil comprises copper windings, whereas the second stator coil comprises aluminum windings. On account of the higher resistance of aluminum, the second stator coil could then, with the heat loss remaining the same, be operated only with a lower current intensity. Consequently, the magnetic field and hence the drive power of the second drive modules would be smaller than those of the first drive modules. However, the costs for the second stator modules are reduced through the use of aluminum.

In one specific embodiment of the linear motor arrangement, the first track extends in the vertical direction, and the angle is greater than 10°. This means that the second track extends at least at an angle of 10° to the vertical. Cars which are moved along the second track are thus likewise subject to a horizontal offset during travel. This allows passenger transport in buildings of novel architecture to occur efficiently. With particular preference, the angle is between 35° and 55° or between 80° and 100°. In the first case, this means that the second track particularly preferably extends along a diagonal, whereas the second case describes a substantially horizontal track.

In a very particularly preferred embodiment, the first track extends vertically and the second track horizontally, with the result that the first track forms an angle of 90° relative to the second track.

The invention can be applied in particular in an elevator installation comprising a car which can move along a first track and a second track, and a linear motor arrangement of the above-described type.

In this case, the car particularly comprises a rotor unit having at least one rotor magnet. Here, the first drive train is designed to generate a magnetic field which travels in the direction of the first track and with which the at least one rotor magnet can be magnetically impinged for the purpose of driving the rotor unit. Furthermore, the second drive train is designed to generate a magnetic field which travels in the direction of the second track and with which the at least one rotor magnet can be magnetically impinged for the purpose of driving the rotor unit.

The elevator installation particularly comprises a plurality of, in particular more than two, cars which can move independently of one another along the first track and the second track.

The invention will be explained in more detail below with reference to the figures, in which

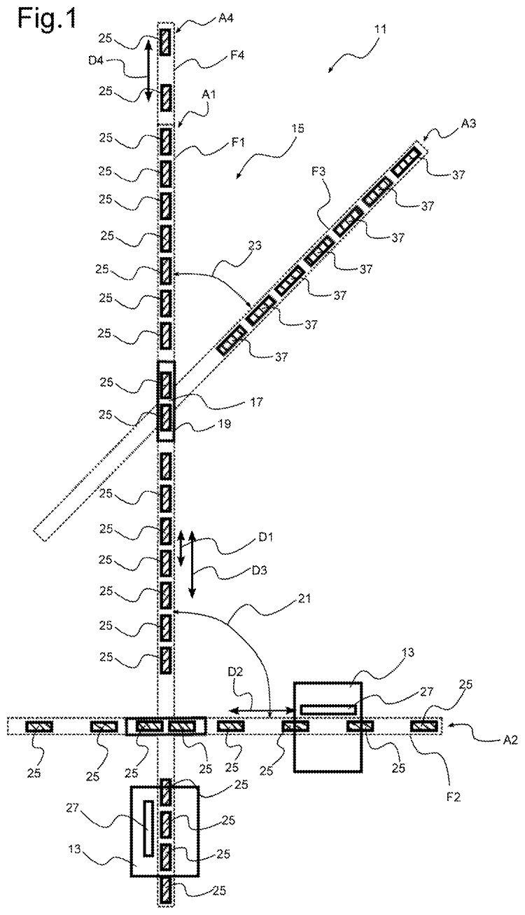

FIG. 1 schematically shows a cross section through an elevator installation; and

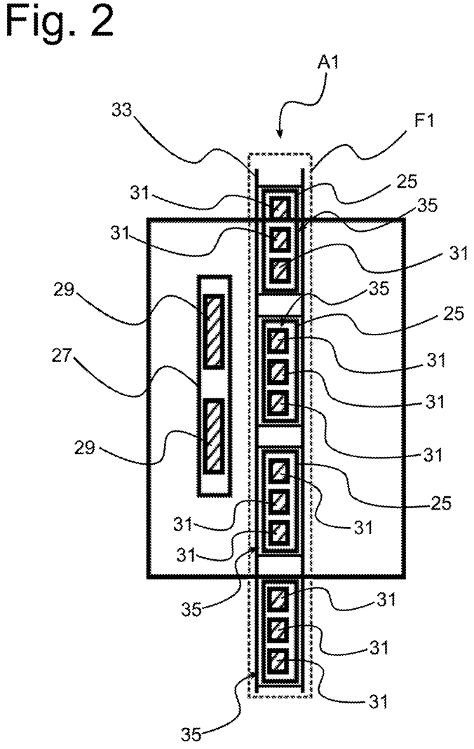

FIG. 2 schematically shows a detail illustration of a car from FIG. 1.

FIG. 1 schematically shows a cross section through an elevator installation 11. The elevator installation 11 comprises two cars 13 which can move along a track F1, a track F2 and a track F3. Furthermore, the elevator installation 11 comprises a linear motor arrangement 15. The linear motor arrangement 15 comprises a drive train A1, a drive train A2 and a drive train A3. Here, the drive train A1 is arranged along the track F1, the drive train A2 is arranged along the track F2, and the drive train A3 is arranged along the track F3. The arrangement of the tracks and drive trains is to be understood here as being merely by way of example. Depending on the specific design of the building, the tracks and drive trains can also assume different profiles. At the crossing points 17 of the tracks there are arranged rotatable rail segments 19 by means of which the cars 13 can change between the different tracks F1, F2, F3. The mode of operation of the rotatable rail segments 19 is disclosed, for example, in DE 10 2015 218 025 A1.

In the present case, the track F1 is oriented vertically and the track F2 horizontally. The track F1 thus connects different floors of the building in which the elevator installation 11 has been incorporated, whereas the track F2 extends along the same floor. The track F1 thus forms an angle 21 with the track F2 that is 90°. By contrast, the track F1 forms an angle 23 with the track F3 that is 45°. The track F3 thus connects different floors of the building while simultaneously producing a horizontal offset. In principle, other configurations of tracks are also possible. Depending on the design of the building, other angles between the tracks may be helpful in order to allow efficient transport of passengers within the building.

The car 13 comprises a rotor unit 27 which interacts with the drive train with which the car 13 is in engagement. In this way, a drive power is transmitted to the rotor unit 27 in order to move the car 13 connected to the rotor unit along the corresponding track. This mode of operation is illustrated in more detail in FIG. 2 for example for a car 13 which moves along the track F1. The drive train A1 is arranged along the track F1. Said drive train comprises a plurality of first drive modules 25. The first drive modules 25 are here incorporated into a mounting holder 33 which for its part is fastened to the shaft wall. For this purpose, the mounting holder 33 comprises receptacles 35 which are suitable for every first drive module 25. The first drive modules 25 for their part comprise at least one first stator coil 31. In the configuration illustrated, the first drive modules 25 each comprise three first stator coils 31. The rotor unit 27 of the car 13 is arranged adjacent to the first drive modules 25. The rotor unit 27 comprises at least one rotor magnet 29 (in the present case two rotor magnets 29). During the operation of the elevator installation 11, the stator coil 31 generates a magnetic field which travels in the direction of the track F1 and with which the at least one rotor magnet 29 can be magnetically impinged. In this way, a drive power is transmitted to the at least one rotor magnet 29 for the purpose of driving the rotor unit 27. The drive power is thus also transmitted to the car 13, which consequently moves along the track F1 corresponding to the traveling magnetic field.

In addition to the configuration of the drive train, the transmitted drive power of course also depends on the configuration of the rotor unit. In particular, the drive power is dependent on the number and magnetic field strength of the rotor magnets. If, within the context of this application, the drive powers or drive power density of two different drive trains are compared, this comparison is to be understood in such a way that the drive powers in both drive trains are transmitted to identical rotor units.

FIG. 1 further shows that the drive train A1 comprises a plurality of first drive modules 25, wherein adjacent first drive modules 25 have a first distance D1 from one another. By contrast, the drive train A2 comprises a plurality of first drive modules 25 which have a second distance D2 from one another. Here, the first distance D1 is less than the second distance D2. The first drive modules 25 are thus arranged more tightly in the drive train A1 than in the drive train A2. The two drive trains thus differ in the property of the density of the first drive modules 25. Since the first drive module 25 in the drive train A1 and in the drive train A2 are otherwise identical, the drive train A1 is suitable for providing a higher drive power density than the drive train A2. This has the advantage that no excessive drive power is held available along the drive train A2. By contrast to the drive train A1 which extends along the vertical track F1, the drive train A2 extends along the horizontal track F2. Thus, for a movement of the car 13 along the track F2, a smaller drive power is required than for a movement along the track F1. Particularly for a movement along the track F1 in the upward direction, it is namely necessary to compensate for the weight force of the car 13. For this purpose, an additional drive power is necessary. By contrast, the weight force of the car 13 when moving along the track F2 is taken up by a guide (not shown), in particular a roller guide. There need thus only be overcome the inertia of the car 13 and the frictional forces occurring by virtue of the guide.

The distance D2 between the first drive modules 25 of the drive train A2 is in the present case equal to a third distance D3 between two first drive modules 25 of the drive train A1 which are not adjacent. In the case of the exemplary configuration shown, the third distance D3 is a distance between two next but one drive modules 25 of the drive train A1. This configuration has the advantage that the same mounting holders 33 can be used for the drive train A1 and the drive train A2. It is only in the drive train A2 that every second receptacle 35 of the mounting holder 33 is not equipped with a first drive module 25 during assembly. Otherwise, the mounting holder 33 can be used unchanged, with the result that no separate components are required. The drive power density in the drive train A2 is thus half the drive power density that the drive train A1 can provide. Correspondingly, just every third, fourth, etc., receptacle 35 of the mounting holder 33 can be equipped with a first drive module 25, with the result that the drive power density is then correspondingly only a third, quarter, etc., by comparison with a completely equipped mounting holder 33.

FIG. 1 further shows the drive train A3 which is arranged along the track F3. The track F3 forms an angle 23 of 45° with the track F1. The drive train A3 comprises a plurality of second drive modules 37. The second drive modules 37 differ from the first drive modules 25 in the drive train A1 by virtue of the fact that the first drive modules 25 are suitable for providing a higher drive power than the second drive modules 37. The two drive trains thus differ in the property that they are equipped with different drive modules. Since the track F3 in the present case extends at an angle of 45° to the vertical (and hence to the track F1), some of the weight force of the car 13 during travel along the track F3 is also taken up by the guide of the car 13. For this reason, a smaller drive power is required along the track F3 than for example along the track F1 which extends vertically. Second drive modules 37 can thus be used for the drive train A3 that provide a smaller drive power and are thus more favorable.

As illustrated in FIG. 2, the first drive modules 25 each comprise at least one first stator coil 31. Correspondingly, the second drive modules each comprise at least one second stator coil. The different drive powers of the first drive modules 25 and of the second drive modules 37 come about by virtue of the fact that the first stator coil 31 has a different design form than the second stator coil. This is achieved for example by the first stator coil 31 comprising a larger number of windings, a larger cross section or a material having a higher magnetic permeability.

FIG. 1 further shows the drive train A4 which is arranged along the track F4. The track F4 is a parking track which adjoins the track F1 and comprises no angle relative to the track F1. The track F4 is arranged in the shaft head, that is to say above the floors which can be approached during normal operation. If, for example, two cars 13 are situated on the track F1, it may be necessary to temporarily park the upper of the two cars 13 in the track F4 in order that the lower of the two cars 13 can approach the uppermost floor. The temporary parking can occur at a lower speed, with the result that a lower drive power is required. For this reason, the drive train A4 along the track F4 comprises a smaller density of the first drive modules 25. The drive train A4 thus comprises a plurality of first drive modules 25 which have a distance D4 from one another. Here, the distance D1 in the drive train A1 is less than the distance D4. The first drive modules 25 are thus arranged more tightly in the drive train A1 than in the drive train A4. Alternatively, analogously to the drive train A3, the drive train A4 can also be equipped with drive modules which provide a smaller drive power.

### LIST OF REFERENCE SIGNS

11 Elevator installation

13 Cars

15 Linear motor arrangement

17 Crossing point

19 Rotatable rail segment

21 Angle

23 Angle

25 First drive modules

27 Rotor unit

29 Rotor magnet

31 Stator coil

33 Mounting holder

35 Receptacle

37 Second drive modules

F1 Track

F2 Track

F3 Track

A1 Drive train

A2 Drive train

A3 Drive train

D1 First distance

D2 Second distance

D3 Third distance

D4 Fourth distance

1.-14. (canceled)

15. A linear motor arrangement suitable for an elevator installation, wherein the elevator installation comprises at least one car, which is movable along a first track and a second track, and wherein the linear motor arrangement is configured to drive the car, the linear motor arrangement comprising:
a first drive train which is arranged along the first track, and
a second drive train which is arranged along the second track,
wherein the first drive train is configured to provide a higher drive power density than the second drive train.

16. The linear motor arrangement of claim 15 wherein the second track is a parking track.

17. The linear motor arrangement of claim 16 the second track is arranged in a shaft head and/or in a shaft pit.

18. A linear motor arrangement suitable for an elevator installation, wherein the elevator installation comprises at least one car, which is movable along a first track and a second track, and wherein the linear motor arrangement is configured to drive the car, the linear motor arrangement comprising:
a first drive train which is arranged along the first track, and
a second drive train which is arranged along the second track,
wherein the first drive train differs from the second drive train in at least one property, and the first track forms an angle relative to the second track.

19. The linear motor arrangement of claim 18 wherein the first drive train is configured to provide a higher drive power density than the second drive train.

20. The linear motor arrangement of claim 18 wherein the first drive train comprises a plurality of first drive modules with a first distance between the first drive modules, and the second drive train comprises a plurality of first drive modules with a second distance between the first drive modules, wherein the first drive train differs from the second drive train by virtue of the fact that the first distance is less than the second distance.

21. The linear motor arrangement as claimed in claim 20 wherein the second distance is equal to a third distance between two first drive modules of the first drive train which are not adjacent.

22. The linear motor arrangement of claim 18 wherein the first drive train comprises a plurality of first drive modules, and the second drive train comprises a plurality of second drive modules, wherein the first drive modules are configured to provide a higher drive power than the second drive modules.

23. The linear motor arrangement of claim 22 wherein the first drive modules each comprise at least one first stator coil, and the second drive modules each comprise at least one second stator coil, wherein the first stator coil comprises a different design form than the second stator coil.

24. The linear motor arrangement of claim 18 wherein the first track extends in a vertical direction, at an angle greater than 10°.

25. The linear motor arrangement of claim 24 wherein the angle is between 35° and 55° or between 80° and 100°.

26. An elevator installation, comprising a car movable along a first track and a second track, and the linear motor arrangement of claim 18 configured to drive the car.

27. The elevator installation as claimed in claim 26 wherein the car comprises a rotor unit with at least one rotor magnet, the first drive train is designed to generate a magnetic field which travels in the direction of the first track and with which the at least one rotor magnet can be magnetically impinged for the purpose of driving the rotor unit, and the second drive train is designed to generate a magnetic field which travels in the direction of the second track and with which the at least one rotor magnet can be magnetically impinged for the purpose of driving the rotor unit.

28. The elevator installation of claim 27 comprising a plurality of cars which are configured to move independently of one another along the first track and the second track.
